(19) United States
(12) Patent Application Publication
(10) Pub. No.: US 2026/0277413 A1
(43) Pub. Date: Sep. 17, 2026

(54) SYSTEM AND METHOD FOR TRANSFORMING DISPLAYED DOCUMENT IN RESPONSE TO FACIAL CONDITIONS

(71) Applicant: JPMorgan Chase Bank, N.A., New York, NY (US)

(72) Inventors: Kevin J. MCNAMARA, Newfoundland, NJ (US); Scott QUINLIN, Montgomery, TX (US)

(73) Assignee: JPMorgan Chase Bank, N.A., New York, NY (US)

(21) Appl. No.: 19/079,225

(22) Filed: Mar. 13, 2025

(51) Int. Cl. G06F 3/04845; G06F 3/01; G06F 40/103

(52) U.S. Cl. CPC G06F 3/04845; G06F 3/013; G06F 40/103

(57) ABSTRACT

A method to transform a document to reduce eye strain is provided. The method includes: receiving an image of a user reading a displayed document on a display; detecting, within the image of the user, one or more visual cues consistent with the user experiencing eye strain reading the document on the display; identifying changes to the displayed document to reduce the eye strain; transforming, in response to the identifying, the document on the display, including: changing a brightness of the displayed document; changing a font size of the displayed document; and/or changing a font type of the displayed document.

### TECHNICAL FIELD

This disclosure relates to methods and apparatuses for using an artificial intelligence/machine learning (AI/ML) model to automatically transform physical characteristic of a displayed document in response to a user's facial conditions.

### BACKGROUND

The developments described in this section are known to the inventors. However, unless otherwise indicated, it should not be assumed that any of the developments described in this section qualify as prior art merely by virtue of their inclusion in this section, or that these developments are known to a person of ordinary skill in the art.

Existing digital document viewing platforms typically rely on static settings for display properties such as brightness, font size, and type. While some systems allow for manual adjustments, these do not account for real-time, user-specific feedback reflecting how a user interacts physically with the content (for example, squinting, screen distance, or pupil dilation). The user many not even know what environmental changes to manually make, or even what changes are available. Consequently, users often experience eye strain or discomfort when engaging with digital documents under varying or suboptimal conditions.

Therefore, there is a need for a system that in real-time adapts to the user's viewing conditions and improves readability by transforming the document on display to make it easier to read.

### SUMMARY

The present disclosure, through one or more of its various aspects, embodiments, and/or specific features or sub-components, provides, among other features, various systems, servers, devices, methods, media, programs, and platforms for using an AI/ML model to automatically transform physical characteristic of a displayed document in response to a user's facial conditions.

According to an embodiment of the invention, a method is provided. The method may include: receiving a native image of a user reading a displayed document on a display; detecting, within the native image of the user, one or more visual cues consistent with the user experiencing eye strain reading the document on the display; identifying changes to the displayed document to reduce the eye strain; transforming, in response to the identifying, the document on the display, including: changing a brightness of the displayed document; changing a font size of the displayed document; and/or changing a font type of the displayed document.

The above embodiment may have various optional features. The one or more visual cues may include squinting, eye dilation, and/or an excessive closeness between the user and the display relative to predefined criteria. The one or more visual cues may include squinting, and the detecting comprises: converting the native image of the user into a color space image; defining an area around an eye in the color space image of the user; and determining within the area a degree of squinting of the eye. The one or more visual cues may include eye dilation, and the detecting comprises: converting the native image of the user into a color space image; defining an area around an eye in the color space image of the user; and determining a size of a pupil relative to a size of an iris based on a contrast between color of the pupil and color of the iris in the area. The one or more visual cues may include squinting and eye dilation, and the detecting comprises: converting the native image of the user into a color space image; defining an area around an eye in the color space image of the user; determining, within the area, a degree of squinting of the eye; and determining a size of a pupil relative to a size of an iris based on a contrast between color of the pupil and color of the iris in the area. The transforming the document may include changing a brightness of the display and comprises sending a signal to a device rendering the display to change the brightness of the display. The transforming the document may include changing a font size of the displayed document and comprises calling and instructing an Application Program Interface (API) to change the font size of content within the document. The transforming the document may include changing a font type of the displayed document and comprises calling and instructing an API to change the font type of content within the document. The method may include returning, after a period of time after the transforming, to the receiving, such that the method is recursive; and the period of time increases over time for at least a predetermined number of recursions.

According to another embodiment of the invention, a non-transitory computer readable media storing instructions programmed to cooperate with a processor to perform operations is provided. The operations may include: receiving a native image of a user reading a displayed document on a display; detecting, within the native image of the user, one or more visual cues consistent with the user experiencing eye strain reading the document on the display; identifying changes to the displayed document to reduce the eye strain; transforming, in response to the identifying, the document on the display, including: changing a brightness of the displayed document; changing a font size of the displayed document; and/or changing a font type of the displayed document.

The above embodiment may have various optional features. The one or more visual cues may include squinting, eye dilation, and/or an excessive closeness between the user and the display relative to predefined criteria. The one or more visual cues may include squinting, and the detecting comprises: converting the native image of the user into a color space image; defining an area around an eye in the color space image of the user; and determining within the area a degree of squinting of the eye. The one or more visual cues may include eye dilation, and the detecting comprises: converting the native image of the user into a color space image; defining an area around an eye in the color space image of the user; and determining a size of a pupil relative to a size of an iris based on a contrast between color of the pupil and color of the iris in the area. The one or more visual cues may include squinting and eye dilation, and the detecting comprises: converting the native image of the user into a color space image; defining an area around an eye in the color space image of the user; determining, within the area, a degree of squinting of the eye; and determining a size of a pupil relative to a size of an iris based on a contrast between color of the pupil and color of the iris in the area. The transforming the document may include changing a brightness of the display and comprises sending a signal to a device rendering the display to change the brightness of the display. The transforming the document may include changing a font size of the displayed document and comprises calling and instructing an Application Program Interface (API) to change the font size of content within the document. The transforming the document may include changing a font type of the displayed document and comprises calling and instructing an API to change the font type of content within the document. The operations may include returning, after a period of time after the transforming, to the receiving, such that the method is recursive; and the period of time increases over time for at least a predetermined number of recursions.

According to yet another embodiment of the invention, a system is provided. The system includes a camera, a display, a processor, and a non-transitory computer readable media storing instructions programmed to cooperate with the processor to perform operations. The operations may include: receiving a native image of a user reading a displayed document on a display; detecting, within the native image of the user, one or more visual cues consistent with the user experiencing eye strain reading the document on the display; identifying changes to the displayed document to reduce the eye strain; transforming, in response to the identifying, the document on the display, including: changing a brightness of the displayed document; changing a font size of the displayed document; and/or changing a font type of the displayed document.

The above embodiment may have various optional features. The one or more visual cues may include squinting, eye dilation, and/or an excessive closeness between the user and the display relative to predefined criteria. The one or more visual cues may include squinting, and the detecting comprises: converting the native image of the user into a color space image; defining an area around an eye in the color space image of the user; and determining within the area a degree of squinting of the eye. The one or more visual cues may include eye dilation, and the detecting comprises: converting the native image of the user into a color space image; defining an area around an eye in the color space image of the user; and determining a size of a pupil relative to a size of an iris based on a contrast between color of the pupil and color of the iris in the area. The one or more visual cues may include squinting and eye dilation, and the detecting comprises: converting the native image of the user into a color space image; defining an area around an eye in the color space image of the user; determining, within the area, a degree of squinting of the eye; and determining a size of a pupil relative to a size of an iris based on a contrast between color of the pupil and color of the iris in the area. The transforming the document may include changing a brightness of the display and comprises sending a signal to a device rendering the display to change the brightness of the display. The transforming the document may include changing a font size of the displayed document and comprises calling and instructing an Application Program Interface (API) to change the font size of content within the document. The transforming the document may include changing a font type of the displayed document and comprises calling and instructing an API to change the font type of content within the document. The operations may include returning, after a period of time after the transforming, to the receiving, such that the method is recursive; and the period of time increases over time for at least a predetermined number of recursions.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a method for using an AI/ML model in accordance with an embodiment.

FIG. 2 illustrates an exemplary diagram of a network environment with a device for using an AI/ML model in accordance with an embodiment.

FIG. 3 illustrates a system diagram for implementing a method for using an AI/ML model in accordance with an embodiment.

FIG. 4 illustrates an exemplary flow chart of a process for using an AI/ML model to automatically transform physical characteristic of a displayed document in response to a user's facial conditions, in accordance with an embodiment.

FIG. 5 illustrates an exemplary flow chart of a process for using an AI/ML model to automatically transform physical characteristic of a displayed document in response to a user's facial conditions, in accordance with an embodiment.

FIG. 6 illustrates an exemplary flow chart of a process for using an AI/ML model to automatically transform physical characteristic of a displayed document in response to a user's facial conditions, in accordance with an embodiment.

FIG. 7 illustrates a model design of components used for a process for using an AI/ML model to automatically transform physical characteristic of a displayed document in response to a user's facial conditions, in accordance with an embodiment.

FIG. 8 illustrates a logical flow that corresponds to a process for using an AI/ML model to automatically transform physical characteristic of a displayed document in response to a user's facial conditions, in accordance with an embodiment.

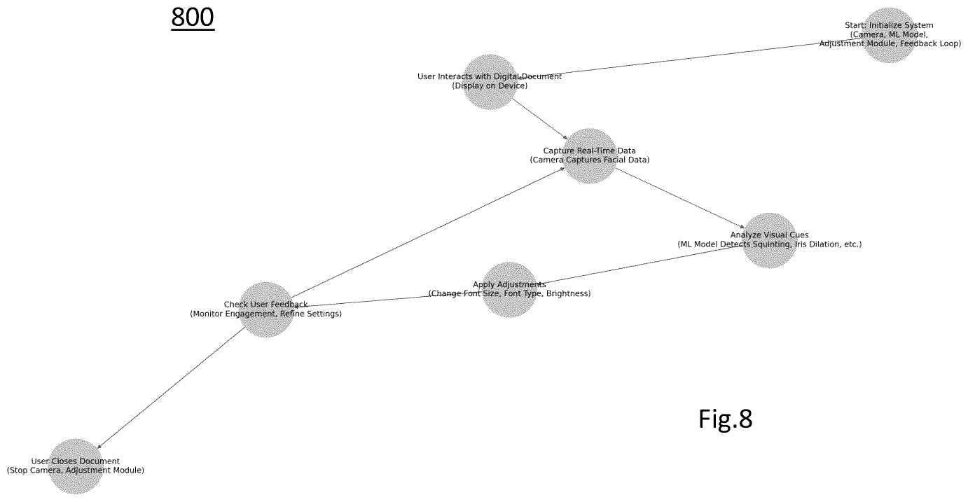

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

References to any “example” herein (e.g., “for example”, “an example of”, by way of example” or the like) are to be considered non-limiting examples regardless of whether expressly stated or not.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various features are described which may be features for some embodiments but not other embodiments.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Existing digital document viewing platforms typically rely on static settings for display properties such as brightness, font size, and type. While some systems allow for manual adjustments, these do not account for real-time, user-specific feedback reflecting how a user interacts physically with the content (for example, squinting, screen distance, or pupil dilation). The user many not even know what environmental changes to manually make, or even what changes are available. Consequently, users often experience eye strain or discomfort when engaging with digital documents under varying or suboptimal conditions.

According to an embodiment of the invention, a method to reduce eye strain is provided. The method may include: receiving an image of a user reading a displayed document on a display; detecting, within the image of the user, one or more visual cues consistent with the user experiencing eye strain reading the document on the display; identifying changes to the displayed document to reduce the eye strain; transforming, in response to the identifying, the document on the display, including: changing a brightness of the displayed document; changing a font size of the displayed document; and/or changing a font type of the displayed document.

The above methodologies provide a technical solution to the above-noted technical problem of addressing eye strain. The methodology automatically detects eye strain while a user is reading a document and transforms the document so that it is easier to read. The conversion of the captured imaged to an RGB image specifically allows for color comparison of eye and face features to make the determinations of face distance, squinting, and pupil dilation as a basis to measure and address document readability.

Several definitions that apply throughout this disclosure will now be presented.

The terms “substantial”, “substantially” or the like are defined to be essentially conforming to the particular dimension, shape, or other feature that the term modifies, such that the component need not be exact. For example, “substantially cylindrical” means that the object resembles a cylinder, but can have one or more deviations from a true cylinder. The terms are used as a modifier to imply “approximate” rather than “perfect.” It is a term of approximation, not a term of degree.

The term “comprising” when utilized means “including, but not necessarily limited to”; it specifically indicates open-ended inclusion or membership in the so-described combination, group, series and the like.

The term “a” means “one or more” unless the context clearly indicates a single element.

The term “about” when used in connection with a numerical value means a variation consistent with the range of error in equipment used to measure the values, for which ±5% may be expected.

“First,” “second,” etc., re labels to distinguish components or blocks of otherwise similar names, but does not imply any sequence or numerical limitation. “And/or” for two possibilities means either or both of the stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities (e.g., at least one A, at least one N, at least one A and at least one N, etc.).

When an element is referred to as being “connected,” or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

As used herein, the term “front”, “rear”, “left,” “right,” “top” and “bottom” or other terms of direction, orientation, and/or relative position are used for explanation and convenience to refer to certain features of this disclosure. However, these terms are not absolute, and should not be construed as limiting this disclosure.

“Display” when used as a noun refers to any digital surface that can render content, and includes by way of non-limiting examples: monitors, tablets, augmented reality, 3D glasses, etc.

“Color space” refers to format in which color or tonal information is encoded in an image. Non-limiting examples of color space formats include: red-green-blue, black-white, grayscale, and hue-saturation-value. This differs from a “normal” or “native” image which is just an image in its basic form without reference to how its colors are encoded.

Shapes as described herein are not considered absolute. As is known in the art, surfaces often have waves, protrusions, holes, recesses, etc. to provide rigidity, strength and functionality. All recitations of shape (e.g., cylindrical) herein are to be considered modified by “substantially” regardless of whether expressly stated in the disclosure or claims, and specifically accounts for variations in the art as noted above.

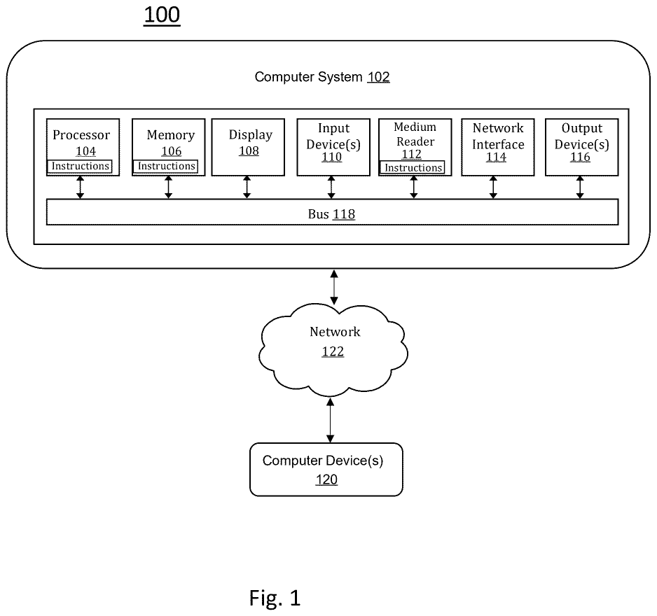

FIG. 1 is an exemplary system 100 for use in implementing a method for using an AI/ML model to automatically transform physical characteristic of a displayed document in response to a user's facial conditions, in accordance with an embodiment. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a GPS device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In some embodiments, the modules implemented by the system 100 may be platform, language, database, and cloud agnostic that may allow for consistent easy orchestration and passing of data through various components to output a desired result regardless of platform, browser, language, database, and cloud environment by writing programs accordingly. The configuration or data files, in some embodiments, may be written using JavaScript Object Notation (JSON), but the disclosure is not limited thereto. For example, the configuration or data files may easily be extended to other readable file formats such as Extensible Markup Language (XML), YAML Ain't Markup Language (YAML), etc., or any other configuration-based languages.

In accordance with various embodiments of the present disclosure, the methods described herein may be implemented using a hardware computer system that executes software programs. Further, in a non-limited embodiment, implementations can include distributed processing, component/object distributed processing, and an operation mode having parallel processing capabilities. Virtual computer system processing may be constructed to implement one or more of the methods or functionality as described herein, and a processor described herein may be used to support a virtual processing environment.

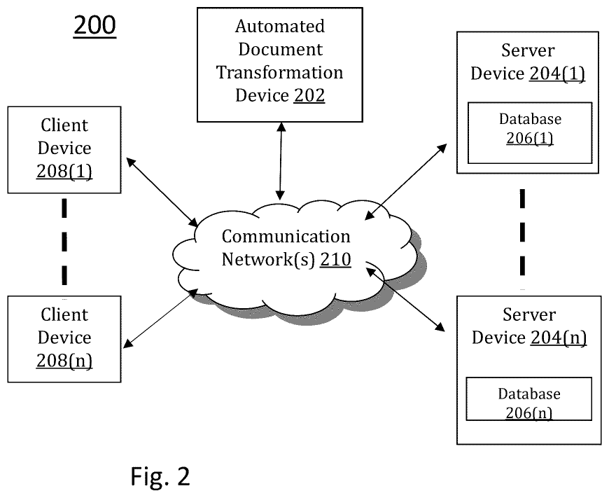

Referring to FIG. 2, a schematic of an exemplary network environment 200 for implementing an automated document transformation device (ADTD) of the instant disclosure is illustrated.

In some embodiments, the above-described problems associated with conventional tools may be overcome by implementing an ADTD 202 as illustrated in FIG. 2 that may be configured for implementing a method for using an AI/ML model to automatically transform physical characteristic of a displayed document in response to a user's facial conditions. but the disclosure is not limited thereto.

The ADTD 202 may have one or more computer system 102s, as described with respect to FIG. 1, which in aggregate provide the necessary functions.

The ADTD 202 may store one or more applications that can include executable instructions that, when executed by the ADTD 202, cause the ADTD 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the ADTD 202 itself, may be located in virtual server(s) running in a cloud-based computing environment rather than being tied to one or more specific physical network computing devices. Also, the application(s) may be running in one or more virtual machines (VMs) executing on the ADTD 202. Additionally, in one or more embodiments of this technology, virtual machine(s) running on the ADTD 202 may be managed or supervised by a hypervisor.

In the network environment 200 of FIG. 2, the ADTD 202 is coupled to a plurality of server devices 204(1)-204(n) that hosts a plurality of databases 206(1)-206(n), and also to a plurality of client devices 208(1)-208(n) via communication network(s) 210. A communication interface of the ADTD 202, such as the network interface 114 of the computer system 102 of FIG. 1, operatively couples and communicates between the ADTD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the ADTD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The ADTD 202 may be a standalone device or integrated with one or more other devices or apparatuses, such as one or more of the server devices 204(1)-204(n), for example. In one particular example, the ADTD 202 may be hosted by one of the server devices 204(1)-204(n), and other arrangements are also possible. Moreover, one or more of the devices of the ADTD 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the ADTD 202 via the communication network(s) 210 according to the HyperText Transfer Protocol (HTTP)-based and/or JSON protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store various types of data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that can facilitate the implementation of the ADTD 202 that may efficiently provide a platform for implementing a method for using an AI/ML model to automatically transform physical characteristic of a displayed document in response to a user's facial conditions, but the disclosure is not limited thereto.

The client devices 208(1)-208(n) may run interface applications, such as standard web browsers or standalone client applications, which may provide an interface to communicate with the ADTD 202 via the communication network(s) 210 in order to communicate user requests. The client devices 208(1)-208(n) may further include, among other features, a display device, such as a display screen or touchscreen, and/or an input device, such as a keyboard, for example.

Although the exemplary network environment 200 with the ADTD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the ADTD 202, the server devices 204(1)-204(n), or the client devices 208(1)-208(n), for example, may be configured to operate as virtual instances on the same physical machine. For example, one or more of the ADTD 202, the server devices 204(1)-204(n), or the client devices 208(1)-208(n) may operate on the same physical device rather than as separate devices communicating through communication network(s) 210. Additionally, there may be more or fewer ADTDs 202, server devices 204(1)-204(n), or client devices 208(1)-208(n) than illustrated in FIG. 2. In some embodiments, the ADTD 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

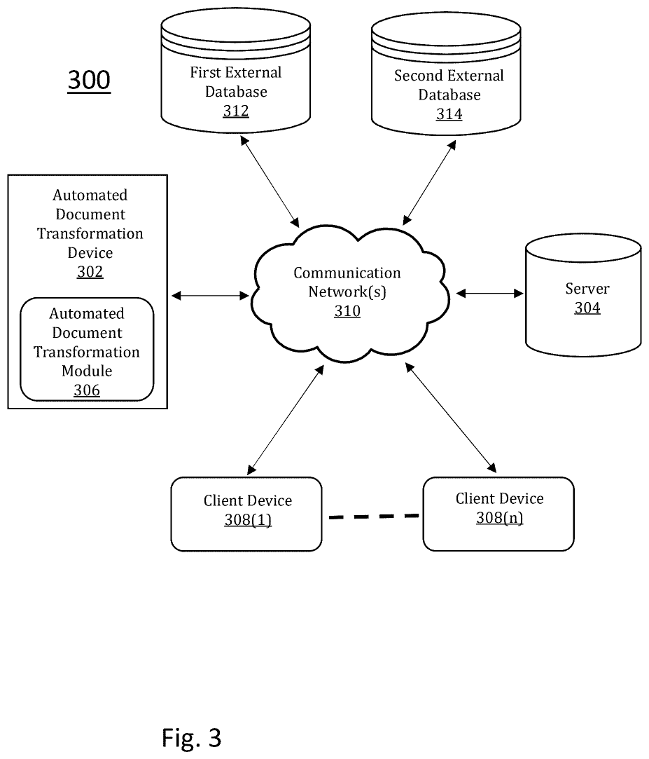

FIG. 3 illustrates a system diagram for implementing an ADTD 302 having an automated document transformation module (ADTM), in accordance with an embodiment.

As illustrated in FIG. 3, the system 300 may include an ADTD 302 within which an ADTM 306 is embedded, a server 304, a first external database 312, a second external database 314, a plurality of client devices 308(1) . . . 308(n), and a communication network 310.

In some embodiments, the ADTD 302 including the ADTM 306 may be connected to the server 304, and the database(s) 312 via the communication network 310. The ADTD 302 may also be connected to the plurality of client devices 308(1) . . . 308(n) via the communication network 310, but the disclosure is not limited thereto.

In an embodiment, the ADTD 302 is described and shown in FIG. 3 as including the ADTM 306, although it may include other rules, policies, modules, databases, or applications, for example. In some embodiments, the first external database 312 and/or the second external database 314 may be configured to store ready to use modules written for each application programming interface (API) for all environments. Although only one database is illustrated in FIG. 3, the disclosure is not limited thereto. Any number of desired databases may be utilized for use in the disclosed invention herein. The databases 312, 314 may be a mainframe database, a log database that may produce programming for searching, monitoring, and analyzing machine-generated data via a web interface, etc., but the disclosure is not limited thereto.

In some embodiments, the ADTM 306 may be configured to receive real-time feed of data from the plurality of client devices 308(1) . . . 308(n) and secondary sources via the communication network 310.

The plurality of client devices 308(1) . . . 308(n) are illustrated as being in communication with the ADTD 302. In this regard, the plurality of client devices 308(1) . . . 308(n) may be “clients” (e.g., customers) of the ADTD 302 and are described herein as such. Nevertheless, it is to be known and understood that the plurality of client devices 308(1) . . . 308(n) need not necessarily be “clients” of the ADTD 302, or any entity described in association therewith herein. Any additional or alternative relationship may exist between either or both of the plurality of client devices 308(1) . . . 308(n) and the ADTD 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. For example, in an embodiment, one or more of the plurality of client devices 308(1) . . . 308(n) may communicate with the ADTD 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The ADTD 302 may be the same or similar to the ADTD 202 as described with respect to FIG. 2, including any features or combination of features described with respect thereto.

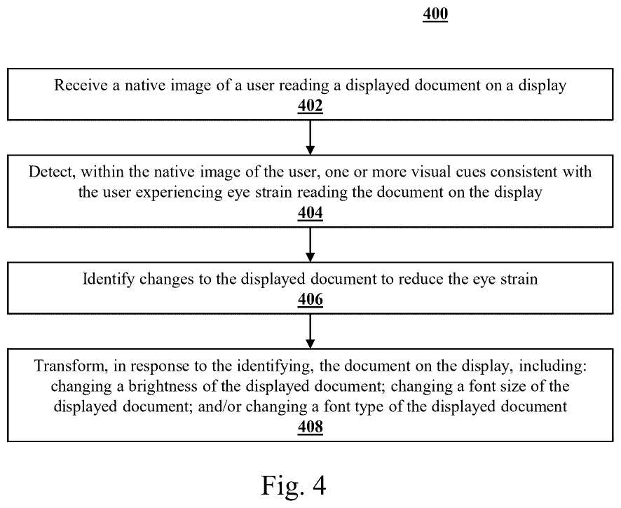

FIG. 4 illustrates an exemplary flow chart of a process 400 implemented by the ADTM 306 of FIG. 3 for enablement of a system and a method for using an AI/ML model to automatically transform physical characteristic of a displayed document in response to a user's facial conditions, in accordance with an embodiment. It may be appreciated that the illustrated process 400 and associated steps may be performed in a different order, with illustrated steps omitted, with additional steps added, or with a combination of reordered, combined, omitted, or additional steps.

As illustrated in FIG. 4, at step S402, the process 400 may include receiving an image of a user reading a displayed document on a display.

At step 404, the process 400 may including detecting, within the image of the user, one or more visual cues consistent with the user experiencing eye strain reading the document on the display.

At step 406, the process 400 may include identifying transformations to the displayed document to reduce the eye strain.

At step 408, the process 400 may include transforming, in response to the identifying, the document on the display. The transformation may include changing a brightness of the displayed document, changing a font size of the displayed document, and/or changing a font type of the displayed document.

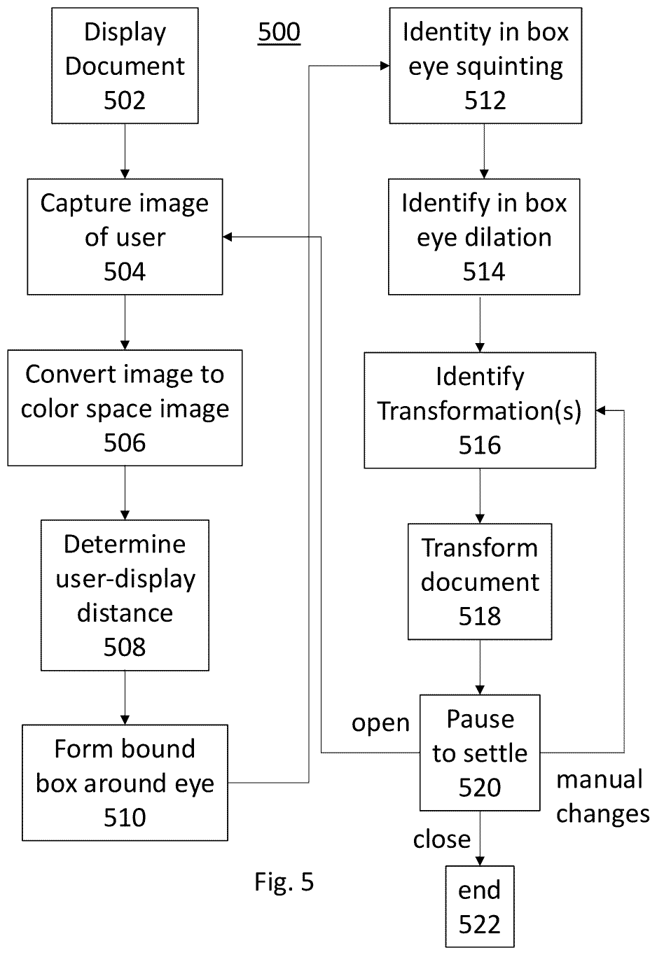

Referring now to FIG. 5, a document transformation process 500 is shown according to an embodiment.

At step 502, a document is displayed on a display. At step 504, an image of the user observing the displayed screen is taken. This could be a single camera image taken, or an image extracted from a video feed. The invention is not limited to the manner in which the image is obtained.

At step 506, the image is converted from its native format into a color space image (e.g., a red-green-blue (RGB) image), a black and white image, or a grayscale image). The conversion reduces noise in the original image and will allow for later color contrast within the image.

At step 508, an AI/ML model determines the distance between the user's face and the display based upon a size of the face relative to the background in the color space image per predetermined criteria. If the user is close to the display, the user's face will occupy a large percentage of color space image. If the user is further away from the screen, the user's face will occupy a small percentage of the color space image. Excessive closeness per predetermined criteria (e.g., the face occupies 70% or more of the screen) is an indicator of eye strain. Distance determinations may account for different cameras or camera settings (e.g., zoom or field of vision angle), as the same user-camera distance may appear differently for different cameras and/or camera settings.

At step 510, a portion of the color space image is created around one of the user's eyes. This process may be referred to as forming a bound box, but the invention is not limited to any particular shape of the portion.

At step 512, the AI/ML model identifies within the bound box physical characteristic consistent with squinting based on the shape of the eye such as the physical distance the eyelids as shown by the color of the eyelids in color space relative to the colors of the eye. This may be a Yes/No finding of squinting, or a degree of squinting as a numerical representation.

At step 514, the AI/ML model identifies within the bound box physical characteristic consistent with eye dilation based on the size of the pupil relative to the size of the iris as indicated by the color of the pupil and iris in color space.

Steps 512 and 514 above are described as using the same bound box for the same eye. However, the invention is not so limited, and different band boxes may be used, for the same eye or for different eyes, from the same image or from different images.

At step 516, the AI/ML model will identify transformations to the displayed document to improve the user's viewing experience. Non-limiting options are to increase/decrease display brightness, increase/decrease font size (e.g., 12 pt to 14pt), change font to a more easily readable font (e.g., from a serif to a sans-serif font, or to a front that is well known as easily readable such as Helvetica, Georgia, or Verdana). Another non-limiting option would be to change the colors of the font and/or background page to improve contrast.

Note the transformation is of the document itself and/or the operating system that renders the document and does not alter the substantive content of the document.

At step 518, the methodology transforms the document per the identified transformations. The nature of the transformation itself may be dependent upon the operating environment and/or the program or app that is rendering the content.

By way of non-limiting example, changing the brightness of the display may be specific to the operating system of the device, be it a computer, smartphone or tablet, and may be further different based on manufacturer (e.g., Apple operating system v. Google operating system). The AI/ML can identify the appropriate command for the specific operating environment or generate a more generic command that the operating environment can convert into a specific command for its environment. The operating system can then change the display brightness accordingly.

Similarly, changing font size or font type may be specific to the operating system of the supporting device or the program rendering the document. For example, display of an email document on a phone may only require changing the font size on the phone, whereas display of a Word document on a laptop may require calling and instructing an API to adjust the font size or font type in Word.

The above transformations may occur all at once, or incrementally so as to present a smoother transition to user. By way of non-limiting example, if the methodology determines that brightness should increase from 3 to 8, the transformation could be 3 directly to 8, or indirectly 3 to 4, then 4 to 5, etc. If the methodology determines that the font should increase from 8 to 14, then the transformation could be 8 directly to 14, or indirectly 8 to 10, then 10 to 12, etc. The invention is not limited to the manner in which the transformation is made.

In another non-limiting example, the transformations may be partial to see how the user adjusts to the partial transformation. Per the above non-limiting examples, if the methodology determines that brightness should increase from 3 to 8, then the transformation might be limited to 60% of the change (or some other predetermined or calculated value) from 3 to 6, and then further adjust during a recursion of the method as discussed below.

At step 520 the methodology will pause for a predetermined amount of time, and then allow control to return to step 504 to take a new image of the user if the document remains open (or to close the process at 522 if the document is closed). In this way the process is recursive to account for changes in user behavior, particularly in response to the transformation of the document.

It is expected that over time the user will adapt to the changes. Accordingly, the predetermined time of the pause may increase over time. By way of non-limiting example, the image could be taken at 1, 2, 4, 8, 16, 32, and 64 seconds, with each image being sampled at 64 seconds thereafter. In another example, the image could be taken every second for the first 5 seconds, then at 10 seconds for the next minute, etc. The invention is not limited to the specific timing of the recursive image taking.

To reflect user adaptation, at each recursion, or after a certain number of recursions, the tolerance to changes at step 516 and/or 518 may increase so as to avoid abrupt changes in the document. By way of non-limiting example, when the pause reaches 64 seconds, the methodology may require significant changes in the eye or face relative to predetermined criteria before changing the displayed document; a 30% change in shape of the eye is a non-limiting example of such pre-determined criteria, but the invention is not limited to any particular criteria.

The user may manually override the changes at any time. When control is at 520, the methodology would track these changes and note the same for reference in the identifying transformations at step 516. For example, if methodology increased the brightness and the user responded by reducing brightness, then during a return to step 516 the methodology would not increase the brightness even though the methodology determines a brightness increase would be appropriate.

It may be determined by any of the relevant steps that the user is either not in the image, or not facing the document (e.g., the user is not paying attention to the document). In this case, control may proceed from the relevant step to step 520 to pause before taking the next image. Step 520 can adjust timing to sample for user return, such as by way of non-limiting example sampling every 1 second, and then timing out to step 522 if the user does not reengage after a predetermined period of time.

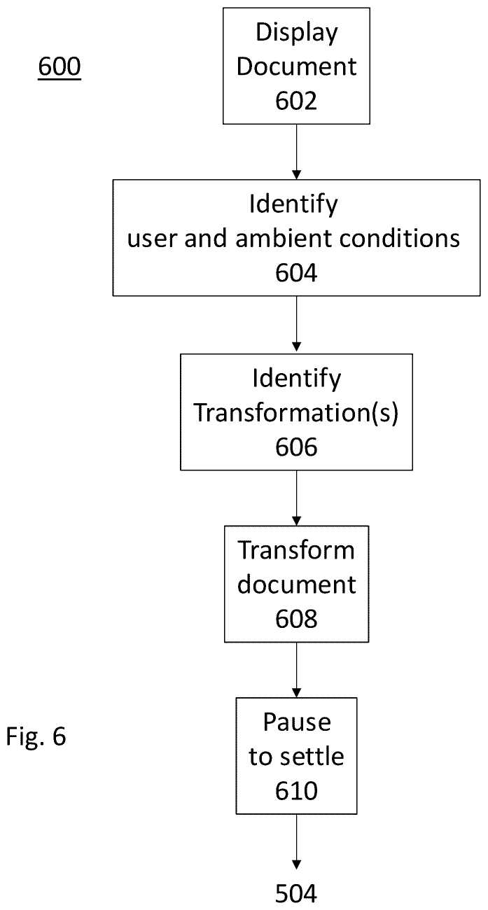

Referring now to FIG. 6, a process 600 is shown. This process is based upon the methodology having already run through process 500 in FIG. 5 such that there is a baseline of user parameters for the particular user to view a document. Once a document is identified for display, the user is identified at step 604, such as by visual identification from an image or a login ID. Document transformations for the specific user, based on a selection of prior transformations for that specific user, are identified at step 606 and applied at step 608. After a pause for the changes to settle at step 610, control passes to 504 in FIG. 5 to allow for any fine tuning.

Baseline parameters could be specific to certain ambient conditions as could be detected at step 604, such as whether the user is in a dark room or a bright room, and for which the user may experience eye strain differently based on those ambient conditions. The identifying of transformations could thus be environmentally dependent, with different baselines available for use based on the different conditions.

The above methodologies provide a technical solution to the above-noted technical problem of addressing eye strain. The methodology automatically detects eye strain while a user is reading a document and transforms the document so that it is easier to read. The conversion of the captured imaged to an color space image specifically allows for color comparison of eye and face features to make the determinations of face distance, squinting, and pupil dilation as a basis to measure and address document readability.

Various embodiments herein thus provide a system and method for automatically enhancing the readability of digital documents based on real-time facial and eye-tracking data. More specifically, the invention employs machine learning models—such as custom neural networks, convolutional neural networks (CNNs), or liquid neural networks—to monitor a user's facial expressions and eye behavior, and then dynamically adjust the document display to maximize visual comfort and clarity.

When a user opens a digital reading surface (e.g., a website, mobile application, or e-reader), the camera on the user's device captures images or video of the user's face. A machine learning model processes the captured data to identify indicators of difficulty in viewing the screen, including squinting, excessive closeness of the user's face to the screen, and/or pupil dilation or other ocular indicators suggesting suboptimal viewing conditions.

Based on these indicators, the system automatically adjusts one or more display settings, such as brightness/illumination, font size, and/or font type. These adjustments can be made continuously and in real-time to respond to any changes in the user's engagement level or the ambient environment, without requiring manual intervention. The system also incorporates a feedback loop to further refine and optimize display settings until the user's viewing experience is ideal.

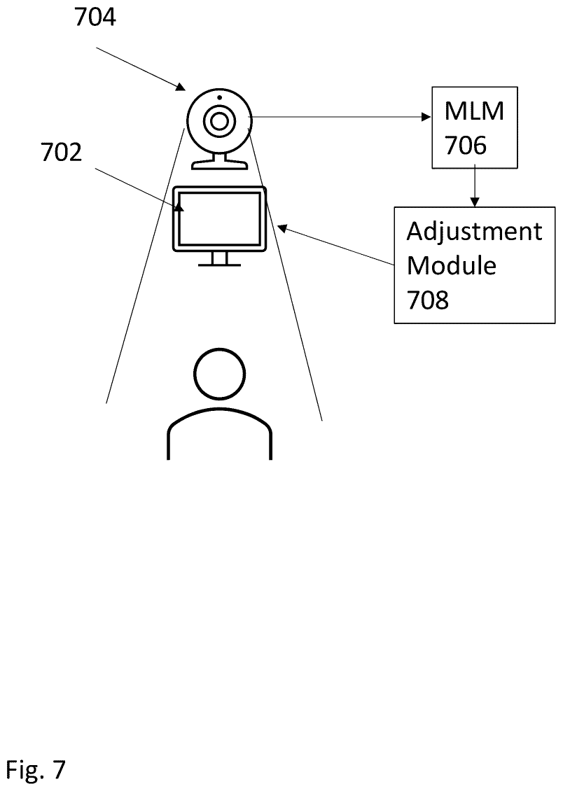

Referring to FIG. 7, the supporting system may include: a digital device 702 such as a smartphone, tablet, or computer; a camera 704 configured to capture the user's facial expressions and eye movement; a machine learning based module 706, which could be implemented locally on the device via a cloud-based surface to process the camera feed in real-time; and an adjustment module 708 that issues commands to automatically alter the display properties (e.g., brightness, font size, font type) of the document.

In operation, once the user opens a digital document (e.g., e-book, webpage, PDF reader), the camera begins capturing images of the user's face. These images are then fed into the machine learning model to detect any conditions suggesting eye strain.

The system may utilize one or more types of neural networks: Custom Neural Networks: Specifically trained to detect subtle cues in facial expressions—such as the onset of squinting and variations in iris dilation—that indicate readability issues.

Convolutional Neural Networks (CNNs): Well-suited for image processing tasks, CNNs can quickly identify patterns or features associated with face-to-screen distance, blurred vision cues, or facial strain.

Liquid Neural Networks: Provide adaptive learning capabilities to update model parameters in real-time as the user's conditions change or as new data becomes available.

When the machine learning model identifies that the user's visual comfort is compromised, the adjustment module can take one or more automatic actions, including but not limited to:

Brightness Adjustment: Increasing or decreasing screen illumination to compensate for ambient lighting or user's perceived strain.

Font Size Scaling: Enlarging or reducing the font size based on the distance between the user's face and the screen.

Font Type Change: Switching to a more readable font (e.g., from a serif to a sans-serif font) if the model detects the user is having difficulty distinguishing letter shapes.

The methodology operates under a continuous feedback loop that re-evaluates the user's facial expressions and eye behavior after each adjustment. If the model detects that further improvements are necessary, it automatically fine-tunes the display settings, or conversely, reverts them if the user's eye strain appears to have worsened.

By collecting and analyzing data from multiple users over time, the system can also improve its predictive capabilities, making it more accurate and user-friendly. This ongoing learning process can be incorporated as part of liquid neural network updates or through periodic retraining of custom networks.

Referring now to FIG. 7, a logic flow 700 to implement an embodiment of the invention is shown.

Below is pseudo code to implement an embodiment.
#Step 1: Initialize the system
Initialize Camera
Initialize MachineLearningModel
Initialize AdjustmentModule
Initialize FeedbackLoop
#Step 2: User reads a digital document
Display DigitalDocument on Device
#Step 3: Capture real-time data
While User is interacting with DigitalDocument:
   CameraData=CaptureFacialData(Camera)
#Step 4: Analyze user's visual cues
   VisualCues=MachineLearningModel.Analyze(CameraData)
#Step 5: Identify adjustments needed
   If VisualCues includes “Squinting”:
      AdjustmentModule.Adjust(“FontSize”, “Increase”)
   If VisualCues includes “CloseToScreen”:
      AdjustmentModule.Adjust(“FontSize”, “Decrease”)
   If VisualCues includes “IrisDilation”:
      AdjustmentModule.Adjust(“Brightness”, “Increase”)
   If VisualCues includes “DiscomfortWithFont”:
      AdjustmentModule.Adjust(“FontType”, “SansSerif”)
#Step 6: Apply adjustments to the display
   Apply Adjustments to DigitalDocument
#Step 7: Check user feedback
   UserFeedback=MonitorUserEngagement(CameraData)
   If UserFeedback indicates “Strain”:
      FeedbackLoop.RefineAdjustments()
#Step 8: Terminate adjustments when user finishes
If User closes DigitalDocument:
   Stop Camera
   Stop AdjustmentModule
   Exit

In some embodiments as disclosed above in FIGS. 1-7, technical improvements effected by the instant disclosure may include a platform to automatically transform physical characteristic of a displayed document in response to a user's facial conditions, but the disclosure is not limited thereto.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium may be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description.

What is claimed is:

1. A method, comprising:
receiving a native image of a user reading a displayed document on a display;
detecting, within the native image of the user, one or more visual cues consistent with the user experiencing eye strain reading the document on the display;
identifying changes to the displayed document to reduce the eye strain;
transforming, in response to the identifying, the document on the display, including:
changing a brightness of the displayed document;
changing a font size of the displayed document; and/or
changing a font type of the displayed document.

2. The method of claim 1, where the one or more visual cues include squinting, eye dilation, and/or an excessive closeness between the user and the display relative to predefined criteria.

3. The method of claim 1, wherein the one or more visual cues include squinting, and the detecting comprises:
converting the native image of the user into a color space image;
defining an area around an eye in the color space image of the user; and
determining within the area a degree of squinting of the eye.

4. The method of claim 1, wherein the one or more visual cues include eye dilation, and the detecting comprises:
converting the native image of the user into a color space image;
defining an area around an eye in the color space image of the user; and
determining a size of a pupil relative to a size of an iris based on a contrast between color of the pupil and color of the iris in the area.

5. The method of claim 1, wherein the one or more visual cues include squinting and eye dilation, and the detecting comprises:
converting the native image of the user to a color space image;
defining an area around an eye in the color space image of the user;
determining, within the area, a degree of squinting of the eye; and
determining a size of a pupil relative to a size of an iris based on a contrast between color of the pupil and color of the iris in the area.

6. The method of claim 1, wherein the transforming the document includes changing a brightness of the display and comprises sending a signal to a device rendering the display to change the brightness of the display.

7. The method of claim 1, wherein the transforming the document includes changing a font size of the displayed document and comprises calling and instructing an Application Program Interface (API) to change the font size of content within the document.

8. The method of claim 1, wherein the transforming the document includes changing a font type of the displayed document and comprises calling and instructing an API to change the font type of content within the document.

9. The method of claim 1, further comprising:
returning, after a period of time after the transforming, to the receiving, such that the method is recursive; and
the period of time increases over time for at least a predetermined number of recursions.

10. A non-transitory computer readable media storing instructions programmed to cooperate with a processor to perform operations comprising:
receiving a native image of a user reading a displayed document on a display;
detecting, within the native image of the user, one or more visual cues consistent with the user experiencing eye strain reading the document on the display;
identifying changes to the displayed document to reduce the eye strain;
transforming, in response to the identifying, the document on the display, including:
changing a brightness of the displayed document;
changing a font size of the displayed document; and/or
changing a font type of the displayed document.

11. The non-transitory computer readable media of claim 10, where the one or more visual cues include squinting, eye dilation, and/or an excessive closeness between the user and the display relative to predefined criteria.

12. The non-transitory computer readable media of claim 10, wherein the one or more visual cues include squinting, and the detecting comprises:
converting the native image of the user into a color space image;
defining an area around an eye in the color space image of the user; and
determining within the area a degree of squinting of the eye.

13. The non-transitory computer readable media of claim 10, wherein the one or more visual cues include eye dilation, and the detecting comprises:
converting the native image of the user into a color space image;
defining an area around an eye in the color space image of the user; and
determining a size of a pupil relative to a size of an iris based on a contrast between color of the pupil and color of the iris in the area.

14. The non-transitory computer readable media of claim 10, wherein the one or more visual cues include squinting and eye dilation, and the detecting comprises:
converting the native image of the user into a color space image;
defining an area around an eye in the color space image of the user;
determining, within the area, a degree of squinting of the eye; and
determining a size of a pupil relative to a size of an iris based on a contrast between color of the pupil and color of the iris in the area.

15. The non-transitory computer readable media of claim 10, wherein the transforming the document includes changing a brightness of the display and comprises sending a signal to a device rendering the display to change the brightness of the display.

16. The non-transitory computer readable media of claim 10, wherein the transforming the document includes changing a font size of the displayed document and comprises calling and instructing an Application Program Interface (API) to change the font size of content within the document.

17. The non-transitory computer readable media of claim 10, wherein the transforming the document includes changing a font type of the displayed document and comprises calling and instructing an API to change the font type of content within the document.

18. The non-transitory computer readable media of claim 10, the operations further comprising:
returning, after a period of time after the transforming, to the receiving, such that the method is recursive; and
the period of time increases over time for at least a predetermined number of recursions.

19. A system, comprising:
a camera;
a display;
a processor;
a non-transitory computer readable media storing instructions programmed to cooperate with a process to perform operations comprising:
receiving a native image of a user reading a displayed document on the display;
detecting, within the native image of the user, one or more visual cues consistent with the user experiencing eye strain reading the document on the display;
identifying changes to the displayed document to reduce the eye strain;
transforming, in response to the identifying, the document on the display, including:
changing a brightness of the displayed document;
changing a font size of the displayed document; and/or
changing a font type of the displayed document.

20. The system of claim 19, where the one or more visual cues include squinting, eye dilation, and/or an excessive closeness between the user and the display relative to predefined criteria.
